(19) United States
(12) Patent Application Publication
(10) Pub. No.: US 2012/0043886 A1
(43) Pub. Date: Feb. 23, 2012

(54) Integrated Heat Conductive Light Emitting Diode (LED) White Light Source Module

(76) Inventors: Hua Ji, Nanjing (CN); Robert Nail Lee, Palo Alto, CA (US)

(21) Appl. No.: 13/098,797

(22) Filed: May 2, 2011

Related U.S. Application Data
(60) Provisional application No. 61/374,938, filed on Aug. 18, 2010.

(51) Int. Cl. H01J 7/44; H01J 7/24

(52) U.S. Cl. 315/51; 315/32

(57) ABSTRACT

This invention discloses a new and advanced light emitting diodes (LEDs) light source module, and more specifically surface mounting LED dice and/or driver circuits on a slim linear Silicon wafer to provide superior heat dissipation capability through eutectic bonding onto a small Silicon base and the overall performance/cost ratio of the LED white light source module by an advanced integrated.

The current invention claims a priority to U.S. 61/374,938 filed on Aug. 18, 2010 and all references are incorporated herewith.

### FIELD OF INVENTION

The present invention generally relates to the light emitting diodes (LEDs) white light source module, and more specifically to improve the overall performance/cost ratio of the LED white light source module by an advanced integrated approach to improve its light extraction through ultra thin film coating of phosphor as well as a structure to improve its heat conduction through eutectic bonding onto a small Silicon base.

### BACKGROUND OF THE INVENTION

The energy-sensitive developments of LED technology has supported by the strong demand of low power consumption, high efficiency and high brightness lightening source. Compared to traditional white light sources, the LED has advantages such as small size, good illumination efficiency, long service life, high response speed, high reliability, and good wear resistance.

Typically, the LED dice is assembled into a sealed package containing electrical connections between the dice and terminal pads exposed on an outer surface of the package. For planar LED pads, which is commonly used today, electrical connections are either by (1) using wire-bonding of LED dice pads (on the top side of LED where EPI layers are), hence, in this case, the dice's bottom (substrate) has to be die-bonded to an electrically insulation base, or, by (2) using die-bonding of LED dice pads, hence, in this case, the dice's top is directly connected to a circuitry base. For vertical LED pads, both of the above (1) and (2) have to be applied to make electrical connections work. Such a package/module enables simple connection of the LED dice to external circuitry and, due the sealing properties of the package, protects the dice from external damage. It is potentially the ultimate electricity-saving solution for global lighting needs if further engineered correctly to maximize the overall performance/cost ratio of a LED white light source module.

Recently, LEDs are commonly used to generate light in a variety of applications ranging from simple low-power indication lights, higher-power LED traffic light clusters, vehicle dashboards, the backlight source of liquid crystal display devices, interior illumination and exterior lights ad LED matrix video displays. Among these applications, the white light source module (which typically adopts blue LEDs coated with, or immersed in, relatively thick film of phosphor) is perhaps the most wanted one due to its service in both BLU (Back Lighting Unit for LCD applications) and general lighting sect.

However, LED dice also is relatively a tiny point source of heat as well as light. Heat dissipation means may affect its quality and reliability, with respect to performance and life. LED dice deteriorates quickly when its temperature rises beyond certain level. Furthermore, trapped light not being emitted from a package (containing LED dice(s)) would convert to heat and increase the burden of heat dissipation.

To make a LED white light source module, the typical current approach is to (1) surface mount LED dice(s) onto a printed circuit board (PCB), (2) then wire-bond to connect electrodes of the LED to a pre-designed circuit, (3) then assemble it in a cup and encapsulate the package with a transparent material, (4) then apply phosphor coating to covert blue light to white light, and is tested and sorted and labeled according to its color temperature, (5) then attach other parts, such as a lens, to it for optical consideration if any. Common practices may combine (3) and (4) by mixing phosphor powder in silicone before curing, and may also include (a) making the cup inside surface reflective to increase photon extraction from the package, (b) applying minimum phosphor coating to reduce photon absorption (hence reducing heat somewhat).

Typically, heat dissipation can be achieved by fixing the LED white light source onto a heat conductive plate which is either connected to, or a part of, external means of heat dissipater such as a metal heat sink. Depending on application designs, the heat sink may dissipate heat via the natural, or forced, convection means.

A drawback with this type of LED light source module is its inefficiency in dissipating heat away from the LED dice. The circuit board substrate and the transparent encapsulate material are typically made from thermally insulating materials which trap heat in LED dice. For example, the commonly used PCB substrate which serves as the conduit for heat to flow to the heat sink is FR4 whose material has a thermal conductivity coefficient of 0.2-0.3 watts per meter Kelvin, while metals (copper or aluminum) would have a thermal conductivity coefficient 1000 times that of FR4. In addition, the rate of heat dissipation is also severely limited by the LED die-bonding material such as silicone glue and/or silver epoxy paste whose thermal conductivity only up to a few percent of metal aluminum. Thus, current LED light source module suffers, in general, 3 heat flow problems: (1) bonding LED dices to PCB by thermally insulating material, (2) PCB itself not good in heat conduction to convey heat to heat sink, (3) inefficient photon extraction rate by current packaging means, especially in the case of blue-to-white light conversion when an extra of thick non-conductive phosphor coating is added.

The poor heat dissipation properties of the current LED light source module cause LED dice temperature rising rapidly and eventually break the dice.

The current invention disclosed an advanced integrated approach as well as a novel structure to provide much superior heat conduction for LED and to remove all the limitations mentioned above and further provide low cost, highly reliable and brighter LED white light source modules.

### SUMMARY OF THE INVENTION

The present invention has been made to overcome the drawbacks in both photon extraction and heat dissipation of current LED white light source modules. The primary objective of the present invention is to provide such a superior LED white light source module to reach the highest performance/cost ratio by using a low-cost mature manufacturing process for easy mass production.

To achieve that objective, the present invention has made following improvements:
(A) applying direct eutectic metal bonding by adopting semiconductor grade Silicone wafer (Si) as the base plate to hold LED dice(s) to make a LED/Si package and to connect such a package to heat-sink directly through eutectic/soldering means, in order to enjoy the high thermal conductivity of Si (about ⅔ of aluminum) for much better heat conduction, as well as the electro-insulation capability of Si;
(B) then, applying ultra thin film coating of phosphor directly on LED/Si package to convert it to a white light source module (at pre-defined color temperature);
(C) or alternatively, such a phosphor coating could be made directly on blue light LED dices before applying (A), making these a stand-alone white light LED dices (at pre-defined color temperature).

The major difficulties of current practices of making LED packages are the limited choices in selecting bonding material which needs to be heat-conductive and electro-insulative at the same time, in order to make the LED package efficient in heat conduction. Adopting the current invention would easily keep electro contacts from shorting as some of the connecting circuits and components can be designed, processed and embedded in the Si wafer, while eutectic bonding would keep heat flowing easily from the LED dice to the Si and from the Si to the heat-sink, since metallic joints pose no blockage to heat conduction and Si itself is a good heat conductive material.

The other major difficulties which current LED white light source makers are facing is the un-controllability of blue photon's optical path and intensity when interacting with phosphor powder particles in a relatively thick film to generate an uniform white light, thus the current practices have ended up modules with a wide range of white light in terms of color temperature, which has resulted in painful number of sorting bins. Adopting the current invention would significantly turn the blue LEDs into white light ones in according to designated color temperature lots within allowable tolerance, since the ultra thin film coating of phosphor is a process with specific and controllable parameters which makes blue-to-white light conversion under an optically much well-defined and tighter condition.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 illustrates the top and side views of the LED/Si packaging of the present invention.

FIG. 2 illustrates the top and side views and the pattern of contact area of LED housing of the present invention.

FIG. 3 illustrates the top and side views of the light source module schematic and various shapes depending on application designs of the present invention.

FIG. 4 illustrates the option for ph-coating on LED/Si package of the present invention.

FIG. 5 illustrates the “T/T” packaging the white LED dice of the present invention.

FIG. 6 illustrates the “B/T” packaging the white LED dice of the present invention.

FIG. 7 illustrates the overall schematic of a LED white light source module of the present invention.

### DETAIL DESCRIPTIONS OF THE INVENTION

The detailed embodiments of the present invention, a highly efficient heat-conductive LED white light source module, comprise many subtle features and improvement. However, the basic embodiments comprise the following two routes (A) and (B). Route (A) describes one preferred embodiment of the invention of related structures and procedures to make a highly efficient heat-conductive LED/Si package for white light source module starting from blue LED dice(s). Route (B) describes another preferred embodiment of the invention of related structures and procedures to make a highly efficient heat-conductive LED/Si package for white light source module starting from white LED dice(s).

(A) Starting from Blue LED Dice(s):

### (A.I) Making a LED/Si Package

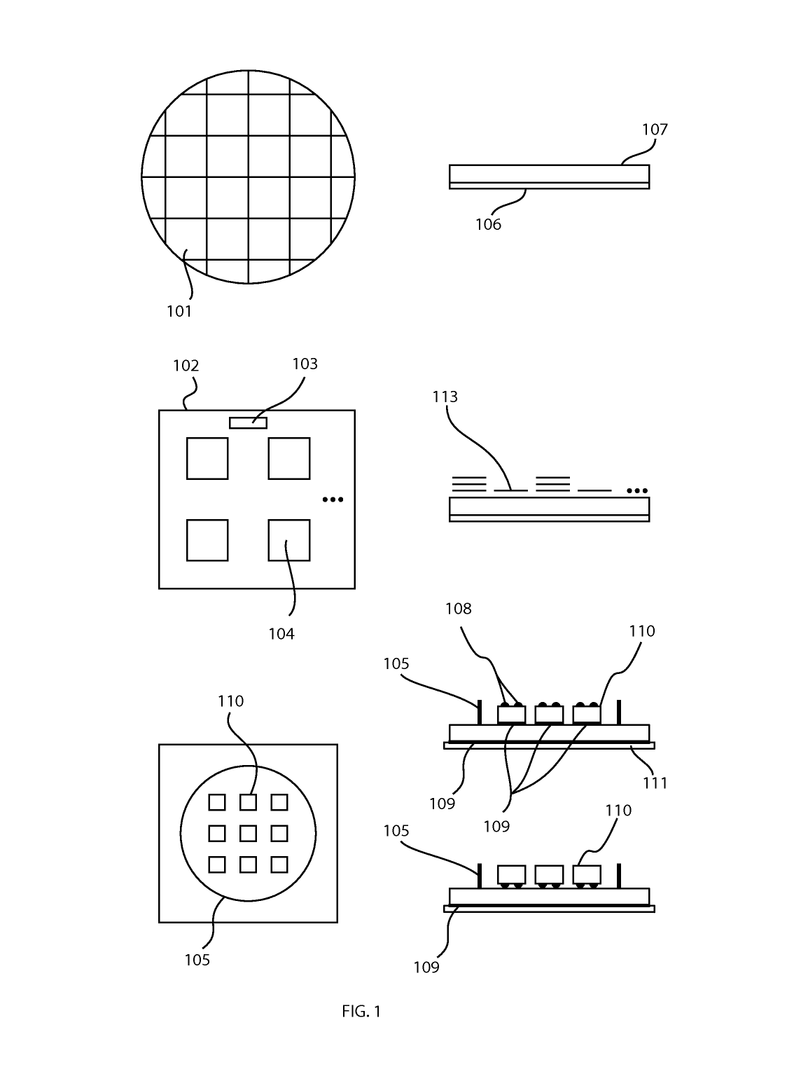

FIG. 1 illustrates the top and side view drawing of the LED light source module on Silicon wafer 101 according to a preferred embodiment of the present invention, where a predesigned circuit 103 is processed in a Silicon wafer 101 as an assembly base to house LED dice(s) 104.
Such a Si base 102 has circuit 103 (and electronic components if suitable cost-wise) processed (from semiconductor foundry services) on the top side. The bottom side of the Si base 102 is coated with eutectic bondable metal 109 layers to provide thermal passage linking the Si base 102 to a heat-sink.
Hereafter the present invention adopts a commonly used coating composition of bondable metal 111 layers, Ti—Ni—Ag 106, as the eutectic means 109, with adding a Sn layer on top of Ag as optional.
Depending on the application design, each of the top side of a Si base 102 has a set of corresponding areas (each area slightly bigger than a LED dice) to house LED dice(s) 104, with each area designated to 1 LED dice.

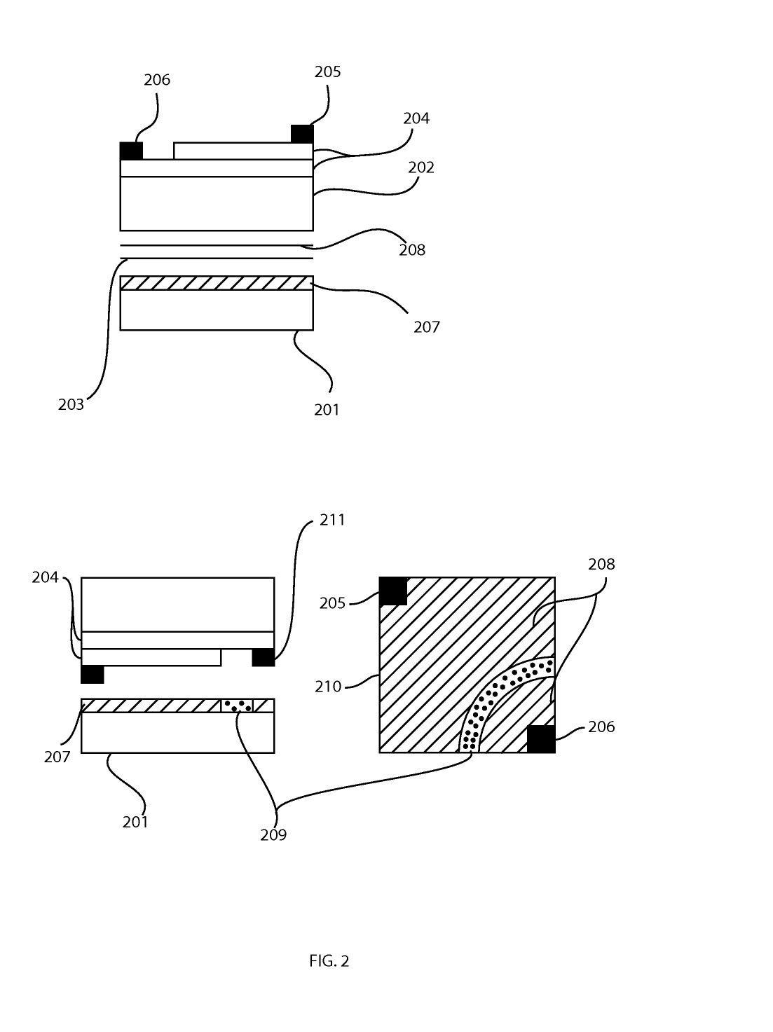

(A.I.1) for Direct Electro-Connection between Planar LED Pads and Si Pads
FIG. 2 illustrates the pattern of contact area of LED dice of the present invention. In this case, all of the top side areas of Si base 201 have electro-pads 207 (but bigger in size) patterned 210 the same way as the LED dice pads 205 206 so as LED pads and Si pads can be bonded together. These Si pads 207 are made with coating of eutectic bondable metal layers to provide electro passages directly linkable to LED pads 205 206. Si pads 207 also serve as the thermal passage linking top side of LED dice to the top side area of Si base 201.

(A.I.2) for Wire-Bonding of Planar LED Pads to Provide Electro-Connection
In this case, all of the top side areas of Si base 201 are coated with eutectic bondable metal layers 203 to serve as the thermal passage linking bottom side of LED dice to the top side area of Si base 201.

(A.I.3) for Wire-Bonding of Vertical LED Pads to Provide Electro-Connection
In this case, all of the top side areas of Si base 201 are coated with eutectic bondable metal layers 203 to serve as the thermal passage linking bottom side of vertical LED dice (which the bottom side is itself a connecting pad) to the top side area of Si base 201.

Then, a plurality of LED dice bonded onto the Si base 201 by applying usual Sn soldering technique (fine Sn—Sb flux preferred) through SMT with reflow or ultrasonic means; and

wherein the said plurality of LED dice bonded to the said predesigned Si base 201 to make it a LED/Si package, hereafter referred to as a “T/T” packaging for a (A.I.1) type and, a “B/T” packaging for (A.I.2) or (A.I.3) type.

### (A.II) Making a LED White Light Source Module

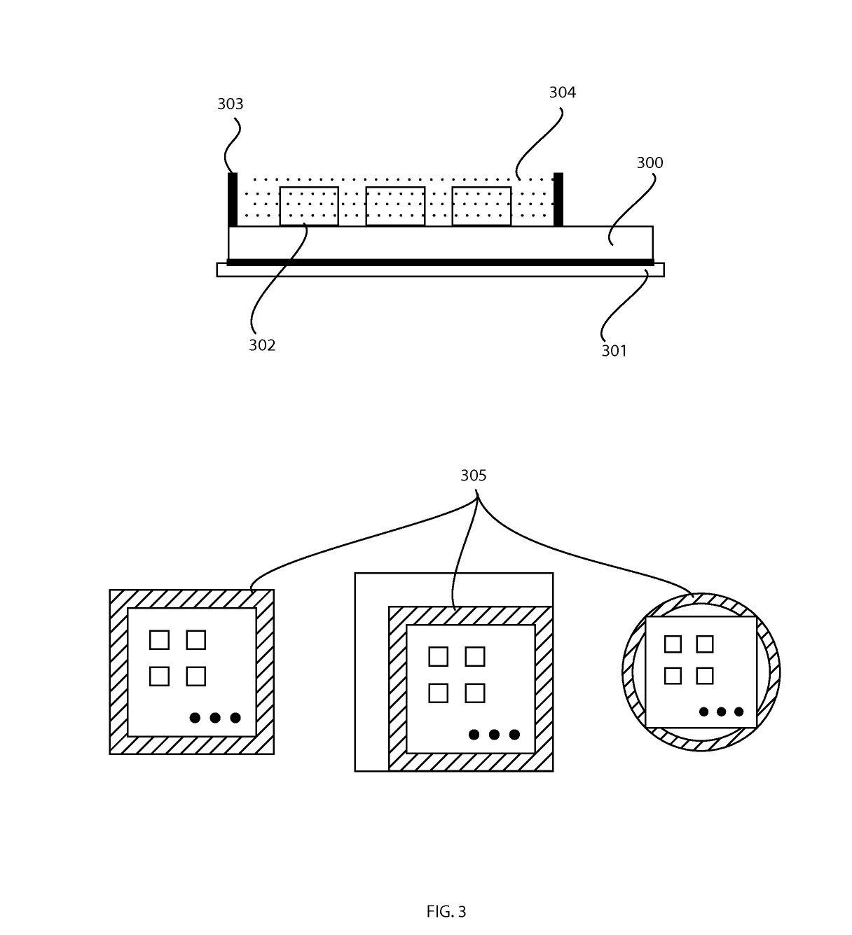

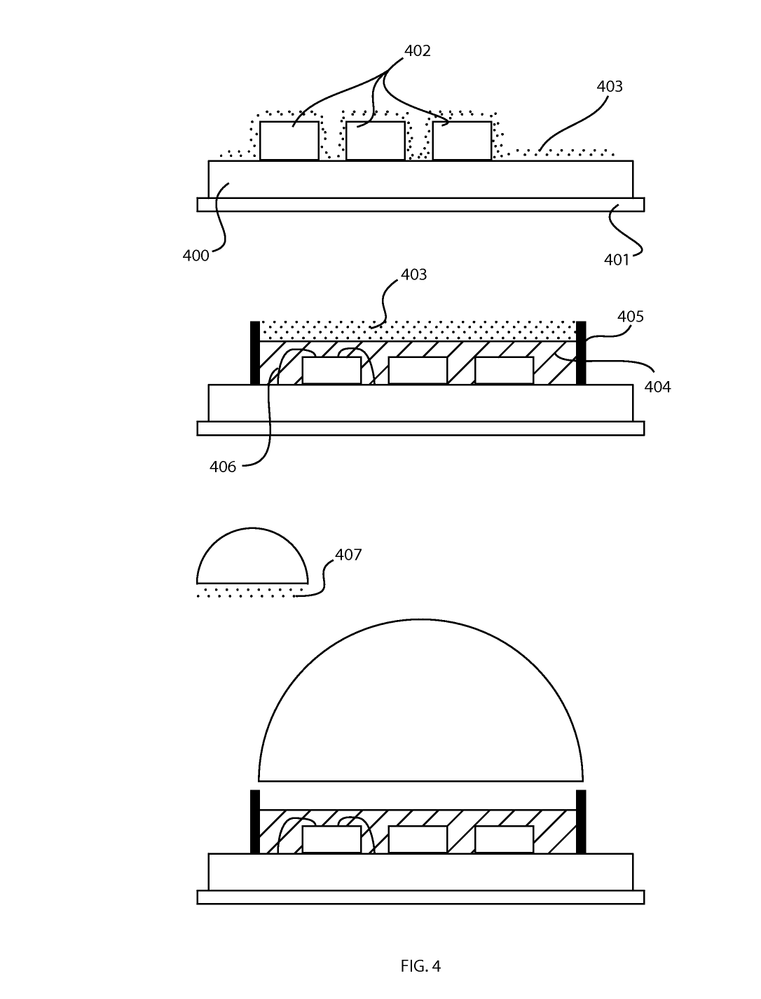

FIG. 3 illustrates the top and side views of the light source module schematic and various shapes depending on application designs of the present invention, where a LED/Si package coated with a conformal ultra thin film of phosphor only on its LED 302 side. FIG. 4 illustrates the option for ph-coating 403 on LED/Si package of the present invention.

(A.II.1) for T/T Packaging
The LED/Si package is ready to be phosphor-coated directly. After phosphor-coating, then put on an electrically isolation cup 303 configured to contain LED dice(s) area, followed by the later processes including filling in encapsulation filler material 304 and/or lens for secondary optics. Note that the addition of cup and/or lens are optional depending on secondary optical designs.

(A.II.1) for B/T packaging
The LED/Si package is (1) to be put on an electrically isolation cup 405 configured to closely confine dice(s) area, (2) wire-bond 406 the LED pads to predesigned circuitry 103, (3) fill in encapsulation filler material 404 and cure the filler to fix/protect the wiring 406. Then it is ready to be phosphor-coated. After phosphor-coating 403, then put on lens 407 etc for optional secondary optics. Note that the above (1) and (3) are optional depending on designs if protection of connection wires can be secured.
Depending on application designs, the number of LED dices can vary a lot, so are the matching Si base 400 designs. The present invention calls for an integrated module of total LED power at 1 W to 100 W, with phosphor-coating thickness averaged at 10 to 100 micron (depending on the particle size distribution of phosphor powder supply), and cup 405 height at 1 to 3 mm.

Then, a phosphor-coated LED/Si package either stand-alone, or its bottom soldered to a predesigned larger piece of metal base sheet 401 (copper preferred) through SMT; and

wherein the said phosphor-coated LED/Si package either by itself, or its bottom soldered to the said predesigned metal base 401, to make it a LED white light source module, ready to be further assembled with other predesigned parts including a simple sheet metal heat sink to make a general lighting device.

(B) Starting from White LED Dice(s):

### (B.I) Making a White LED Dice

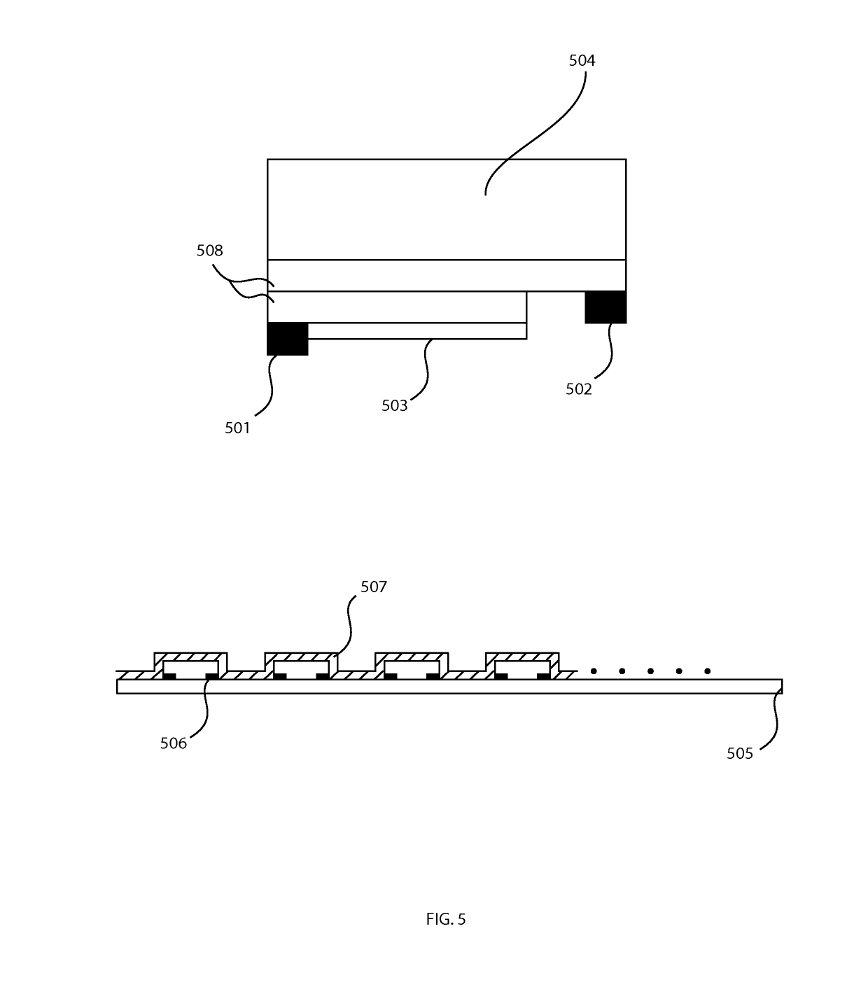

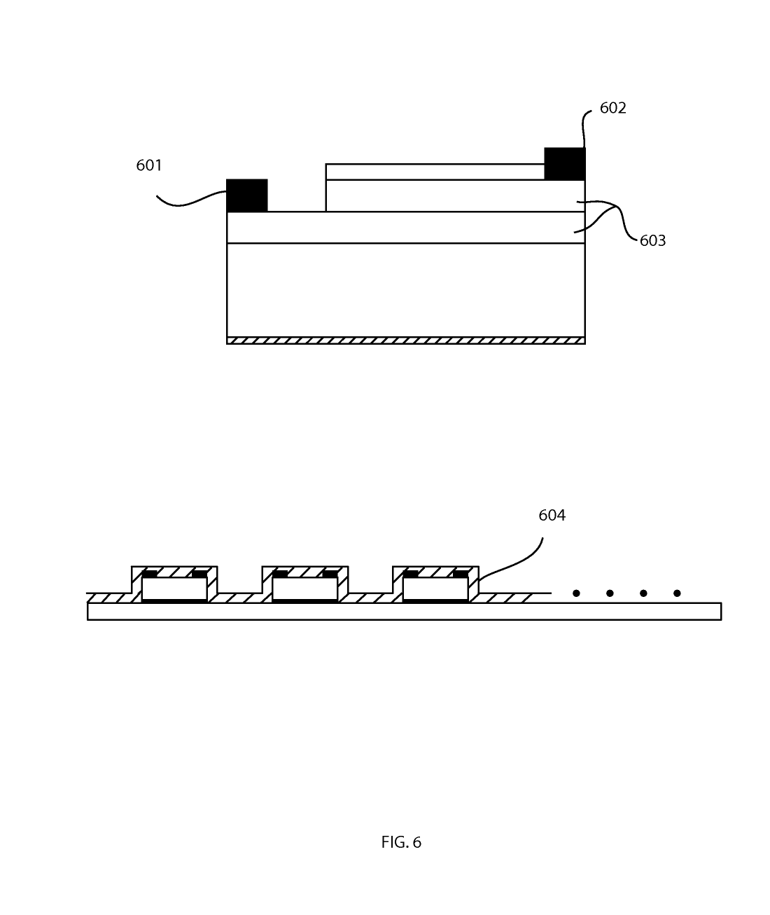

FIG. 5 illustrates the “T/T” packaging the white LED dice of the present invention and FIG. 6 illustrates the “B/T” packaging the white LED dice of the present invention, where a blue LED dice coated with conformal ultra thin phosphor film 507 to make it a white LED dice;

(B.I.1) T/T Type White LED Dice
In this case, blue LED dices 504 are lined up with at least 200 microns gap in between each other and are phosphor-coated 507 604 for pre-tuned film thickness on five sides except their EPI 508 top sides. The present invention calls for naked, un-coated LED substrate sides to be phosphor coated in order to enjoy the maximum white light extraction upon photons leaving the phosphor layer. These white LED dices so made up are then ready to be bonded to the Si base made up following steps as per (A.I.1).

(B.I.2) B/T Type White LED Dice
In this case, blue LED dices are lined up with at least 200 microns gap in between each other and are phosphor-coated 604 for pre-tuned film thickness on five sides except their substrate 600 bottom sides. Then all of the LED pads 601 602 are to be opened up by only removing the coated phosphor on them. These white LED dices so made up are then ready to be bonded to the Si base made up following steps as per (A.I.2)/(A.I.3).

### (B.II) Making a LED White Light Source Module,

A plurality of white LED dice bonded onto the Si base per steps as defined in (A.II) only without phosphor-coating procedures; and

wherein the said white LED dice bonded to the said Si base to form a LED/Si package and then, with or without its bottom soldered to a piece of predesigned metal sheet base to make it a LED white light source module, ready to be applied along with other predesigned parts to make a general lighting device.

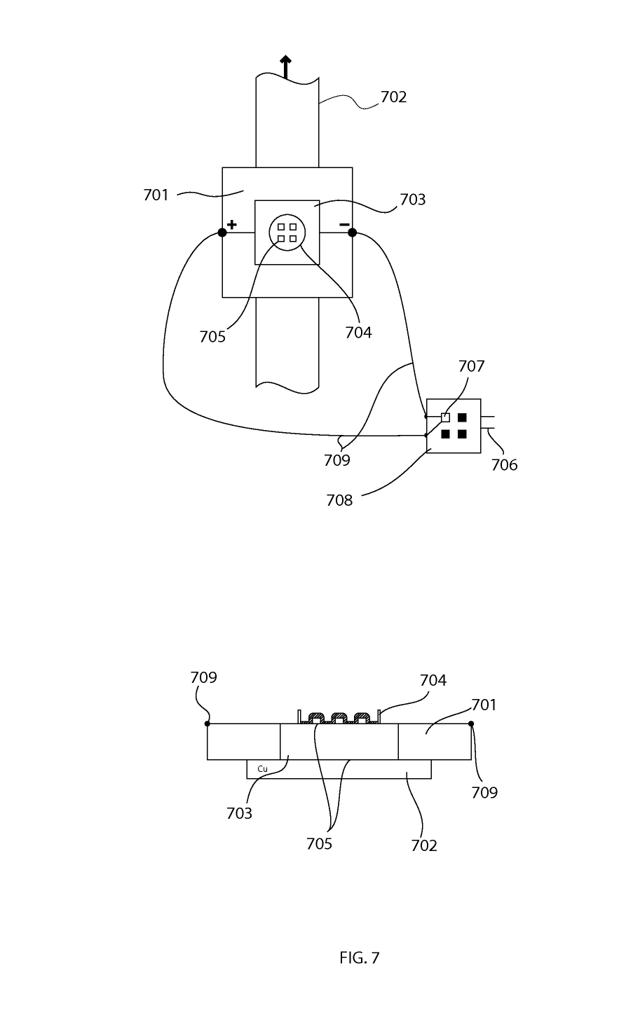

FIG. 7 illustrates the overall schematic of a LED white light source module of the present invention, where a Printed Circuit Board fixture 701 is the assembly base with heathink metal 702 connected to the Si base 703 as described above and power supply 706, 708.

A large number of light facilities applications can be enabled by the invention, two simple examples are described for basic reference.

### (GL) Applying a LED White Light Source Module to Make General Lighting Devices

A white light of uniform color temperature (defined in according to order, say 2500 K to 10000 K) within tolerance can be accomplished by directly applying the said LED white light source module for producing general lighting devices, such as commonly used various kinds of light bulbs or tubes.

### (BLU) Applying White LED Dices to Make BLU

A white light of uniform color temperature (defined in according to order, say 8000 K to 15000 K) within tolerance can be accomplished for a BLU by directly replacing the current BLU's blue LED dices with the said white LED dices, and save the blue-to-white light conversion process during the production of current BLU assemblies.

Although illustrative embodiments have been described herein with reference to the accompanying drawings is exemplary of a preferred present invention, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

1. A highly efficient heat-conductive Light Emitting Diode (LED) light source module comprising
a predesigned printed circuit board or a patterned assembly;
a slim linear Silicon wafer base for direct surface contact between LED's and Silicon (Si) surface;
a plurality of LED dice bonded on a slim linear Silicon wafer base; and
a separate driver integrated circuit (IC),
wherein the said plurality of LED dice are mounted in the said slim linear Silicon base (with or without pre-designed IC's) and connected to the said predesigned printed circuit board to make it a light source module, and
wherein the said plurality of LED dice are either standing alone or configured within an electrically isolation cup with internal reflective surface.

2. The highly efficient heat-conductive LED light source module according to claim 1, wherein the said plurality of LED dice are commercially available planar LEDs (with eutectic bondable reflective coating on substrate bottom side) or vertical LEDs, or
the said plurality of LED dice are commercially available planar LEDs with a naked substrate bottom side;
then die bond these LED dice onto Si base (with corresponding eutectic bondable pre-designed patterns) and make eutectic joins to make thermal/electrical connections between LED dice and Si base;

3. The highly efficient heat-conductive LED light source module according to claim 2, wherein the said light source module are concentrated within a small Si area on the said slim linear Silicon wafer (about a centimeter square) by applying tin based eutectic means between Au or Ag or Cu contacting areas (size of each area ranging from 0.01 to 1 milimeter square);
after eutectic bonding, then wire-bonding the rest contacts in according to electrical circuitry design.

4. The highly efficient heat-conductive LED light source module according to claim 3, further phosphor-coating the said light source module on its pre-designed light emitting side to get blue/white light conversion.

5. The highly efficient heat-conductive LED light source module according to claim 4, wherein the said light source module may be configured (if so designed) within an electrically isolation cup with internal reflective surface (and Phosphor coated lens/diffuser parts may be mounted if so designed) and cure the filled material in the said cup;
then the said module bottom of the said slim linear Silicon wafer base are further soldered to a pre-designed metal heat sink assembly.

6. The highly efficient heat-conductive LED light source module according to claim 5, wherein the said plurality of LED dice are connected to a pre-designed power supply assembly including driver IC and other components.

7. The highly efficient heat-conductive LED light source module according to claim 6, wherein the said module driver IC may also be connected to the said slim linear Silicon wafer base by
a) embedding the said driver IC design by processing directly on the said same Si wafer base through foundry services, or
b) bonding the said driver IC on the said slim linear Si wafer base.
